(19) United States
(12) Patent Application Publication
(10) Pub. No.: US 2026/0260209 A1
(43) Pub. Date: Sep. 3, 2026

(54) SYSTEM FOR SUPPLY CHAIN MANAGEMENT AND A METHOD OF OPERATION THEREOF

(71) Applicants: SCI-TECH CENTRE, West Mumbai, Maharashtra (IN); VANTAGE NUTRITION LLP, Mumbai, Maharashtra (IN)

(72) Inventors: Karan SINGH, West Mumbai, Maharashtra (IN); Werner BONGERS, West Mumbai, Maharashtra (IN); Mahesh BARDE, West Mumbai, Maharashtra (IN); Pranab NATH, West Mumbai, Maharashtra (IN)

(21) Appl. No.: 19/478,819

(22) PCT Filed: Apr. 12, 2024
(86) PCT No.: PCT/IN2024/050383

§ 371 Date: Oct. 26, 2025

(30) Foreign Application Priority Data
Apr. 26, 2023 (IN) 202321030124

(51) Int. Cl. G06Q 10/087; G06Q 50/04

(52) U.S. Cl. CPC G06Q 10/087; G06Q 50/04

(57) ABSTRACT

The present invention relates to a system and a method for supply chain management in a production unit. The method, performed by a server unit (118, 218), comprises receiving from scanners (110), scanned data associated with device markers (108-A/120-A/208-A) before installing devices (108/120/208), and product markers (106-A/114-A/206-A) before feeding raw materials (106/206) and products (114). Further, the method comprises comparing the scanned data of device markers with desired device data, and the scanned data of product markers with desired product data. Furthermore, the method comprises determining an eligibility of each of the devices to be installed into a manufacturing unit (102) and a processing unit (104/204) based on the comparison, and an eligibility of raw materials to be fed into the devices based on comparison. The method comprises providing information indicative of the eligibility of each of devices and eligibility of raw materials to operators.

### FIELD OF THE INVENTION

The present disclosure relates generally to a supply chain management, and particularly, the present disclosure relates to a system for the supply chain management and a method of using the system for supply chain management.

### BACKGROUND

Supply chain management in a production unit is known for managing manufacturing and processing of products and involves multiple stations for such manufacturing and processing of the products. The products may be processed in separate units of the production unit before the products are finally delivered for use. Further, raw materials required for manufacturing of the products also needed to be fed into a manufacturing unit for manufacturing of such products. The manufacturing and processing of such products may be done in separate units. For such manufacturing and processing, the products need to be transferred from one unit of the production unit to another.

The production units generally include a manufacturing unit for manufacturing products and a processing unit for processing the manufactured products. The manufacturing unit and the processing unit include various devices that are deployed for performing manufacturing and processing operations. Such devices are required to be installed in the correct manufacturing unit and/or the processing unit for desired results. However, conventional production units do not include any system(s) that can track the proper installation of such devices into the production unit.

Furthermore, during the transfer of the products from one device to another, it becomes difficult to keep track of the product being fed into a particular device. Such an inability to keep track of the products being fed into the particular device may lead to the feeding of undesired products into the particular device. Such undesired products may result in the manufacturing of poor-quality products, expired products, wrong products, hazardous products, etc. into the devices of the manufacturing units or the processing units. Further, counterfeit products may be fed into the manufacturing units or the processing units. Feeding the undesired products or the counterfeited products into the manufacturing units or the processing unit may further lead to delivery of the undesired products for sale in the market. Sale of such undesired products may harm the goodwill and reputation of companies involved in manufacturing such products.

### SUMMARY

This summary is provided to introduce a selection of concepts, in a simplified format, that are further described in the detailed description of the invention. This summary is neither intended to identify key or essential inventive concepts of the invention nor is intended for determining the scope of the invention.

According to an embodiment of the present disclosure, disclosed herein is a method for supply chain management in a production unit. The method includes receiving, by a server unit of the system for the supply chain management, from a plurality of scanners, scanned data associated with a plurality of device markers before installing a plurality of devices in at least one manufacturing unit and at least one processing unit, and a plurality of product markers before feeding a plurality of raw materials and a plurality of products into the plurality of devices. Further, the method includes comparing, by the server unit, the scanned data of the plurality of device markers with desired device data stored in the server unit, and the scanned data of the plurality of product markers with desired product data stored in the server unit. Furthermore, the method includes determining, by the server unit, an eligibility of each of the plurality of devices to be installed into the at least one manufacturing unit and the at least one processing unit based on the comparison, and an eligibility of the plurality of raw materials to be fed into the plurality of devices based on the comparison. In addition, the method includes providing, by the server unit, information indicative of the eligibility of each of the plurality of devices and the eligibility of the plurality of raw materials as an output to one or more operators associated with the at least one manufacturing unit, and the at least one processing unit. Further, the method includes storing, by the server unit, the desired device data, the desired product data, and processed product data, wherein the server unit is in communication with the at least one manufacturing unit, the plurality of scanners, and the at least one processing unit. Furthermore, the method includes updating, by the server unit, a current filled volume data of each of the plurality of devices in real-time, the current filled volume data is indicative of a volume of the plurality of raw materials and the plurality of products inside the plurality of devices. In addition, the method includes providing, by the server unit information indicative of a filling status via at least one of a display unit, an alarm, and a light emitting diode (LED) indicator.

According to another embodiment of the present disclosure, disclosed herein is a system for supply chain management in a production unit. The system includes a server unit configured to receive scanned data associated with a plurality of device markers from a plurality of scanners, before installing a plurality of devices into at least one manufacturing unit and at least one processing unit, and a plurality of product markers before feeding a plurality of raw materials and a plurality of products into the plurality of devices. Further, the server unit is configured to compare the scanned data of the plurality of device markers with desired device data stored in the server unit, and the scanned data of the plurality of product markers with desired product data stored in the server unit. Furthermore, the server unit is configured to determine an eligibility of each of the plurality of devices to be installed into the at least one manufacturing unit and the at least one processing unit based on the comparison, and an eligibility of the plurality of raw materials to be fed into the plurality of devices based on the comparison. In addition, the server unit is configured to provide information indicative of the eligibility of each of the plurality of devices and the eligibility of the plurality of raw materials as an output to one or more operators associated with the at least one manufacturing unit, and the at least one processing unit.

The system disclosed herein works based on the data stored in the server unit only, thereby ensuring that all the tasks related to tracking maintain system security. The scanners may be integrated with a Programmable Logical Controller (PLC), thereby being able to process data themselves. This results in accurate and timely tracking of the products being fed and the plurality of devices being installed in the production unit. Furthermore, the system maintains confidentiality by incorporating a close-loop data exchange system. The system further ensures that the product being fed into the plurality of devices is authentic. The system further ensures that the plurality of devices is being installed in the designated location in the production unit.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment of implementation of a system deployed in a production unit for supply chain management, according to an embodiment of the present disclosure;

FIG. 2 depicts an exemplary implementation of the system in a pharmaceutical production unit, according to an embodiment of the present disclosure;

FIG. 3 illustrates a block diagram of a server unit comprising a system for a supply chain management, according to an embodiment of the present disclosure;

FIG. 4 illustrates a block diagram of a plurality of modules of the system for supply chain management, according to an embodiment of the present disclosure; and

FIG. 5 illustrates a process flow depicting a method of using a system for supply chain management, according to an embodiment of the present disclosure.

Further, skilled artisans will appreciate that elements in the drawings are illustrated for simplicity and may not have necessarily been drawn to scale. For example, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a nonexclusive inclusion, such that a process or method that comprises a list of steps does not include only those steps but may include other steps not expressly listed or inherent to such process or method. Similarly, one or more devices or subsystems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and do not limit, restrict, or reduce the spirit and scope of the claims or their equivalents.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility, and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Embodiments of the present invention will be described below in detail with reference to the accompanying drawings.

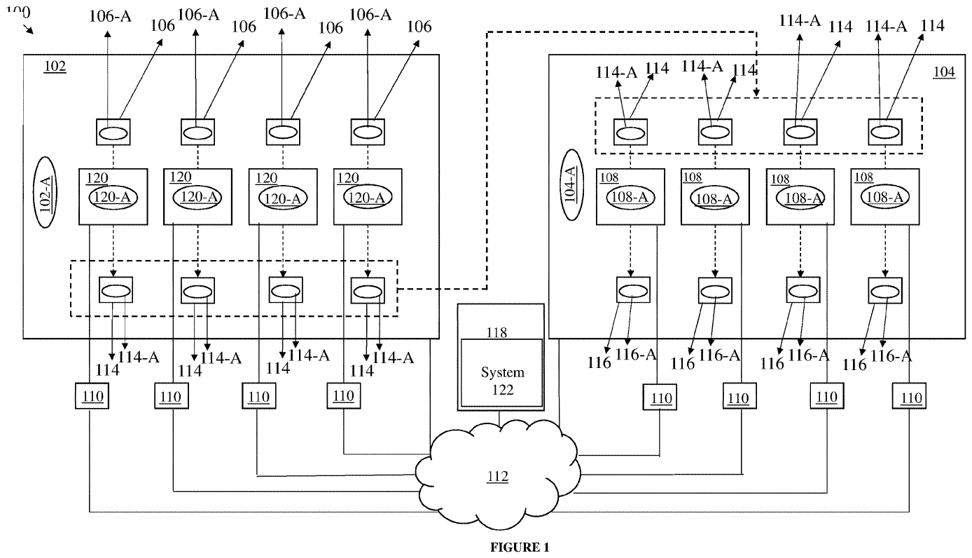

FIG. 1 illustrates a schematic block diagram depicting an environment 100 of implementation of a system deployed in a production unit for supply chain management. The production unit 100 includes at least one manufacturing unit 102, at least one processing unit 104, scanners 110, a server unit 118, and a system 122.

The server unit 118 may be connected to the scanners 110 through a network 112. The network 112 may be a wired network or a wireless network. The network 112 may include, but is not limited to, a mobile network, a broadband network, a Wide Area Network (WAN), a Local Area Network (LAN), and a Personal Area Network.

In one embodiment, the at least one manufacturing unit 102 includes a plurality of manufacturing devices 120, each of which is adapted to perform at least one task related to manufacturing a plurality of products 114 using raw materials 106. Similarly, the at least one processing unit 104 includes a plurality of processing devices 108, each of which is adapted to perform a task related to the processing of the plurality of products 114. It is to be understood that the at least one manufacturing unit 102 and the at least one processing unit 104 have only been used for illustrative purposes, and do not limit the scope of types of units that may be present in the production unit 100.

Once the plurality of products 114 has been manufactured in the at least one manufacturing unit 102, the plurality of products 114 is then transferred to the at least one processing unit 104. The at least one processing unit 104 further processes the plurality of products 114 using the plurality of processing devices 108. In one example, the plurality of products 114 may be processed in the at least one processing unit 104 for functions including, but not limited to, packaging, filling, and embossing. The plurality of manufacturing devices 120 and the plurality of processing devices 108 shall be collectively denoted by the term “devices 108, 120”, hereinafter.

In one embodiment, the environment 100 may include at least one manufacturing unit marker 102-A attached to each of the at least one manufacturing unit 102. Similarly, a processing unit marker 104-A may be attached to each of the at least one processing unit 104, and a device marker 108-A, 120-A may be attached to each of the plurality of devices 108, 120.

In one embodiment, the at least one manufacturing unit marker 102-A may be associated with manufacturing unit data related to each of the at least one manufacturing unit 102. In one example, the manufacturing unit data may include, but is not limited to, a list of functions associated with the at least one manufacturing unit 102, and a list of manufacturing devices 120 installed in the at least one manufacturing unit 102. Similarly, the at least one processing unit marker 104-A may be associated with a processing unit data related to each of the at least one processing unit 104. In one example, the processing unit data may include, but is not limited to, a list of functions associated with the at least one processing unit 104, and a list of processing devices 108 installed in the at least one processing unit 104.

In one embodiment, the device marker 108-A, 120-A is associated with device data related to each of the plurality of devices 108, and 120 installed in the at least one manufacturing unit 102 and the at least one processing unit 104. In one example, the device data may include but is not limited to, a serial number of each of the devices 108, 120, an installation date of each of the devices 108, 120, and a function of each of the devices 108, 120.

In one example, the manufacturing unit marker 120-A, the processing unit marker 104-A, and the device marker 108-A, 120-A may include, but are not limited to, an RFID tag, and a QR code.

In one embodiment, the server unit 118 may include a system 122 adapted to store the manufacturing unit data, the processing unit data, the device data, and the desired device data therein. In another embodiment, a cloud storage may be connected to the server unit 118 for storing the manufacturing unit data, the processing unit data, the device data, and the desired device data therein. The server unit 118 is in communication with the at least one manufacturing unit 102, the scanners 110, and the at least one processing unit 104. The desired device data is indicative of information related to the devices 108, 120 which are compatible for installation in a particular manufacturing unit 102 or a particular processing unit 104. In one example, the desired device data may include, but is not limited to, a compatible serial number of each of the devices 108, 120, a compatible function of each of the devices 108, 120, and a compatible tracking code of each of the devices 108, 120.

During installation of the plurality of devices 108, 120 into the at least one manufacturing unit 102 or the at least one processing unit 104, the device marker 108-A, 120-A of each of the plurality of devices 108, 120 is scanned by a scanning unit (not shown). Data associated with the scanned device marker 108-A, 120-A is then compared with the data associated with the desired device data by the server unit 118. If the scanned device data matches with the desired device data, the device 108, and 120 becomes eligible to be installed into the particular manufacturing unit 102 or the particular processing unit 104 of the production unit 100. Once devices 108, and 120 are approved for installation, the same is installed into the particular manufacturing unit 102 or the particular processing unit 104 and locked therein by a locking system (not shown). In one example, the locking system may include, but is not limited to, a magnetic locking system, a digital locking system, and a mechanical locking system. The locking system may be connected to an indicator which may be adapted to indicate an operator of an instance where the device 108, 120 may be attempted to be unlocked. The operator may refer to individuals or automated systems responsible for controlling, managing, and executing various tasks within the manufacturing unit 102 or the processing unit 104. The tasks may include, but are not limited to, operating machinery, monitoring production processes, ensuring quality control, troubleshoot issues, and implementing safety protocols.

In one embodiment, if the scanned device data does not match the desired device data, the devices 108, and 120 become ineligible to be installed in the particular manufacturing unit 102 or the particular processing unit 104. In such a case, the operator handling installation of the devices 108, and 120 may indicate the ineligibility to install the devices 108, and 120 in the particular manufacturing unit 102 or the particular processing unit 104. In one example, such indication may be made by but is not limited to, a display unit, an alarm, and an LED indicator.

In one embodiment, desired product data against each device data is prestored into the server unit 118. The desired product data is indicative of information related to the raw material 106 or the product 114 which is compatible to be fed into each of the devices 108, 120. In one example, the desired product data may include, but is not limited to, a desired product code, desired contents of the raw material 106 or the product 114, batch number of the raw material 106 or the product 114, and balance quantity of the raw material 106 or the product 114.

The product markers 106-A, and 114-A on each the raw material 106 or the product 114 are scanned before the raw material 106 or the product 114 is fed into the particular device 108, 120. The information associated with the scanned product marker 106-A, 114-A is then compared with the desired product data against the device data of the device 108, 120 in which the product 106, 114 is to be fed, by the server unit 118. If the scanned product data matches with the desired product data, the raw material 106 or the product 114 becomes eligible to be fed into the particular device 108, 120.

In one embodiment, if the scanned product data does not match the desired product data, the raw material 106 or the product 114 becomes ineligible to be fed into the particular device 108, 120. In such a case, an operator handling feeding of the raw material 106 or the product 114 may be indicated about the ineligibility to feed the raw material 106 or the product 114 into the particular device 108, 120. In one example, such indication may be made by, but is not limited to, a display unit, an alarm, and an LED indicator.

In one embodiment, the device-related data may include a maximum volume of each of the devices 108, 120, amongst other device-related data. The maximum volume is indicative of a maximum amount of the raw material 106 or the product 114 that can be fed into each of the devices 108, 120. Once the raw material 106 or the product 114 is started to be fed into the particular device 108, 120, a current filled volume of the particular device 108, 120 may be updated simultaneously in the server unit 118. The current filled volume may be indicative of a volume that has already been filled by the raw materials 106 or the products inside the particular device 108, 120. Once the current filled volume reaches a value equal to the maximum volume of the particular device 108, 120 being fed, the operator may indicate that the particular device 108, 120 is full, and further feeding of the raw material 106 or the product 114 must not be done into the particular device 108, 120. In one embodiment, the operator may be indicated about the filling of the particular device 108, 120 to the maximum value by a volume indicator. In one example, the volume indicator may include, but is not limited to, a display unit, an alarm, and an LED indicator.

Once the products 114 have been processed in the at least one processing unit 104, processed products 116 are then prepared for further operations, or are transported for sale thereafter. In one example, the processed products 116 may include processed product markers 116-A. Each of the processed product markers 116-A is unique for each processed product 116. In one example, the processed product marker 116-A, may include, but is not limited to, an RFID tag, and a QR code. In one embodiment, the processed product markers 116-A are associated with processed product data related to each of the processed products 116. In one example, the processed product data may include, but is not limited to, a processed product code, contents of the processed product 116, expiry date of the processed product 116, a manufacturing date of the processed product 116, batch number of the processed product 116, and balance quantity of the processed product 116. The processed product data may be fed into the server unit 118 and may be accessible when the processed product marker is scanned in a sales unit or by any other operator.

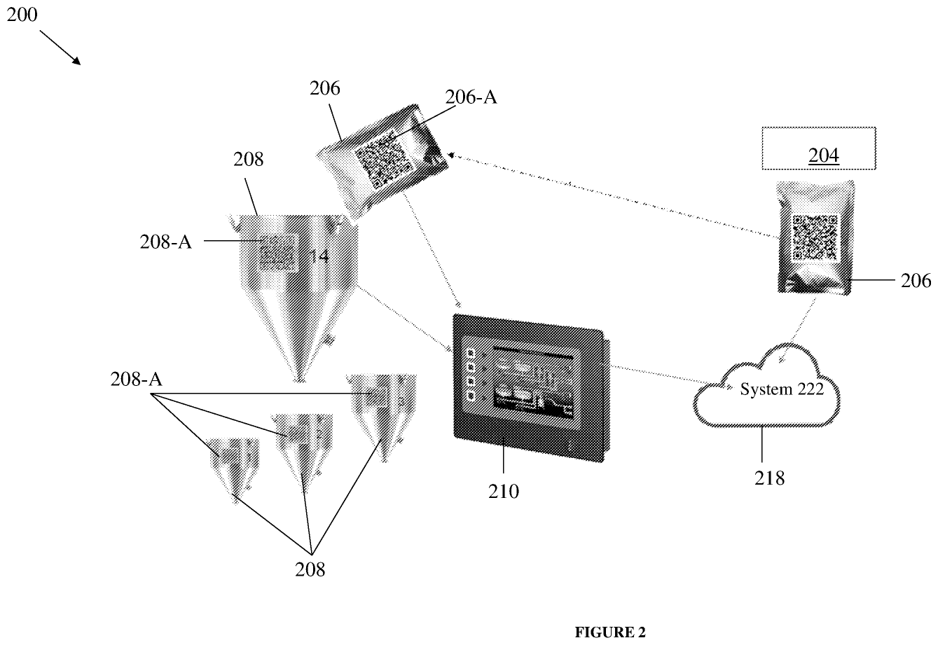

Now referring to FIG. 2, an exemplary implementation of the system will be explained in detail. Specifically, FIG. 2 depicts an exemplary implementation of the system in a pharmaceutical production unit 200. The pharmaceutical production unit 200 includes a medicine manufacturing unit (not shown) and a capsule processing unit 204, such as a capsule filling unit, for filling and packaging of a medicinal product 206 in capsules (not shown). In one example, the medicinal product 206 may include, but is not limited to, a medicinal drug, an ointment, and a health supplement.

The pharmaceutical production unit 200 further includes a server unit 218. The server unit 218 includes a system 222. A product code 206-A is attached to the medicinal product 206 once it is manufactured in the medicine manufacturing unit. In one example, the product code 206-A may include, but is not limited, to a Quick Response (QR) code and a Radio Frequency Identification (RFID) code. The product code 206-A, attached to each of the medicinal product 206, is associated with data related to the medicinal product 206. In one example, the data related to the medicinal product 206 may include, but is not limited to, a name of the medicinal product 206, a type of the medicinal product 206, salts of the medicinal product 206, a manufacturing date of the medicinal product 206, an expiry date of the medicinal product 206, a batch number of the medicinal product 206, and a balanced quantity of the medicinal product 206.

The medicinal product 206 with the product code 206-A is then transferred to the capsule processing unit 204 for filling and packaging. The capsule processing unit 204 includes hoppers 208 for filling the medicinal product 206 into the capsules, and then packaging the capsules into leaflets (not shown).

In one embodiment, the capsule processing unit 204 includes at least one processing unit code (not shown) attached to the capsule processing unit 204. In one example, the processing unit code may include, but is not limited to, a QR code and an RFID code. The processing unit code is associated with data related to the capsule processing unit 204. In one example, the data related to the capsule processing unit 204 may include, but is not limited to, a serial number of the capsule processing unit 204, and functions associated with the capsule processing unit 204.

Each of the hoppers 208 includes a hopper code 208-A. In one example, the hopper code 208-A may include, but is not limited to, a QR code, and an RFID code. The hopper code 208-A is attached to each of the hoppers 208 and is associated with data related to each of the hoppers 208. In one example, the data of each of the hoppers 208 may include, but is not limited to, a serial number of the hoppers 208, functions of the hoppers 208, and installation date of the hoppers 208.

In one embodiment, the server unit 218 may include the system 222 adapted to store, but is not limited to, the data related to the capsule processing unit 204, the data related to the hoppers 208, and the data related to the medicinal products 206. The system 222 may further be adapted to store, but is not limited to, desired data for the capsule processing unit 204, hoppers 208, and the medicinal products 206 therein. The server unit 218 is in communication with the medicine manufacturing unit, the capsule processing unit 204, the hoppers 208, and the scanners (not shown).

During installation of the hoppers 208 into the capsule processing unit 204, the hopper code 208-A is scanned by a scanning unit (not shown). Data associated with the hopper code 208-A is then compared with the data associated with a desired hopper data by the system 222. In one embodiment, the desired hopper data may already be stored in the system 222 and be indicated as details of the hopper compatible for installation into the capsule processing unit 204. If the scanned hopper data matches with the desired hopper data, the hoppers 208 become eligible to be installed into the capsule processing unit 204.

In one embodiment, if the scanned hopper data does not match the desired hopper data, the hoppers 208 become ineligible to be installed in the capsule processing unit 204. In such a case, the operator handling installation of the hoppers 208 may be indicated about the ineligibility to install the hoppers 208 in the capsule processing unit 204. In one example, such indication may be made by, but is not limited to, a display unit, an alarm, and an LED indicator.

In one embodiment, the desired medicine data against each hopper data is stored in the server unit 118, 218 of the system 222. In one example, the desired medicine data may be indicative of information related to the medicinal product 206 which is compatible to be fed into the hoppers 208. The product code 206-A on each medicinal product 206 is scanned before the medicinal product 206 is fed into the particular hopper 208. The information associated with the scanned product code 206-A is then compared with the desired medicine data against the hopper data of each of the hoppers 208, in which the medicinal product 206 is to be fed, by the server unit 218. If the scanned medicinal product data matches with the desired medicine data, the medicinal product 206 becomes eligible to be fed into the particular hopper 208.

In one embodiment, if the scanned product data does not match the desired product data, the medicinal product 206 becomes ineligible to be fed into the particular hopper 208. In such a case, the operator handling feeding of the medicinal product 206 may indicate the ineligibility to feed the medicinal product 206 into the particular hopper 208. In one example, such indication may be made by, but is not limited to, a display unit, an alarm, and an LED indicator.

Referring to FIGS. 1 and 2 together, in one embodiment, the production unit 100, and 200 disclosed herein works based on the data stored in the server unit 118, 218 of the system 122, 222 only, thereby ensuring that all the tasks related to tracking maintain system security. The scanners 110 may be integrated with a Programmable Logical Controller (PLC). In such a scenario, the scanner 110 may be connected with the server unit 118, 218. Further, the scanner 110 may be able to process and compare the scanned data itself, with the stored data in the server unit 118, 218 instead of the scanned data being processed by the server unit 118, 218. In this scenario, the processing of data shall be quick and easier, as compared to the scanned data being first sent to the server unit 118, 218 and then being processed.

This results in accurate and timely tracking of products being fed and the devices 108, 120, or hoppers 208 being installed in the production unit 100, 200. Furthermore, the system 122, and 222 maintains confidentiality by incorporating a close-loop data exchange system. The system 122, 222 further ensures that only an authenticated raw material 106 or the product 114, 206 is being fed into the devices 108, 120, or hoppers 208. The system 122, 222 further ensures that devices 108, 120, or hoppers 208 are being installed in the designated location in the production unit 100, 200.

In one embodiment, the production unit 100, 200 may further include an input device 210 (as shown in FIG. 2) for user data entry. In one example, the input device 210 may include, but is not limited to, a Human Machine Interface (HMI) device. The input device 210 may be connected to the server unit 118 for validation of the user data being entered. In an embodiment, the input device 210 may correspond to a smartphone, a camera, a laptop computer, a desktop computer, a wearable device, and any other device capable of detecting corrosion on metal.

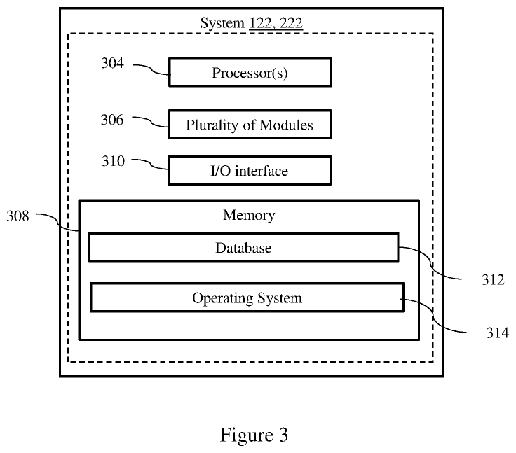

FIG. 3 illustrates a block diagram of a server unit 118, 218 comprising a system 122, 222 for a supply chain management, according to an embodiment of the present disclosure. In an embodiment of the present disclosure, the system 122, 222 may reside in the server unit 118, 218 and is in communication with the input device 210. The system 122, 222 may include, but is not limited to, one or more processors 304, a plurality of modules 306, memory 308, and an Input/Output (I/O) interface 310.

In an exemplary embodiment, the one or more processors 304 may be operatively coupled to each of the plurality of modules 306, the memory 308, and the I/O interface 310. In one embodiment, the one or more processors 304 may include specialized processing units such as integrated system (bus) controllers, memory management control units, floating point units, graphics processing units, digital signal processing units, etc. In one embodiment, the one or more processors 304 may include a central processing unit (CPU), a graphics processing unit (GPU), or both. The one or more processors 304 may be one or more general processors, digital signal processors, application-specific integrated circuits, field-programmable gate arrays, servers, networks, digital circuits, analog circuits, combinations thereof, or other now known or later developed devices for analyzing and processing data. The one or more processors 304 may execute a software program, such as code generated manually (i.e., programmed) to perform the desired operation. In an embodiment of the present disclosure, the one or more processors 304 may be a general-purpose processor, such as the CPU, an application processor (AP), or the like, a graphics-only processing unit such as the GPU, a visual processing unit (VPU), and/or an Artificial Intelligence (AI)-dedicated processor such as a neural processing unit (NPU). In an embodiment of the present disclosure, the one or more processors 304 execute data, and instructions stored in the memory 308 for supply chain management.

The one or more processors 304 may be disposed in communication with one or more input/output (I/O) devices via the respective I/O interface 310. The I/O interface 310 may employ communication code-division multiple access (CDMA), high-speed packet access (HSPA+), global system for mobile communications (GSM), long-term evolution (LTE), WiMax, or the like, etc.

Using the I/O interface 310, the system 122, 222 may communicate with one or more I/O devices, specifically, the user devices associated with the human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc. In an embodiment of the present disclosure, the I/O interface 310 may be used to receive one or more images of the metal from the one or more cameras. Further, the I/O interface 310 may display information indicative of the eligibility of each of the plurality of devices 108, 120, 208 and the eligibility of the plurality of raw materials 106, 206 as an output to one or more operators associated with the at least one manufacturing unit 102, and the at least one processing unit 104, 204.

The one or more processors 304 may be disposed of in communication with a communication network via a network interface. In an embodiment, the network interface may be the I/O interface 310. The network interface may connect to the communication network to enable connection of the system 122, 222 with the outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, and the like.

In some embodiments, the memory 308 may be communicatively coupled to the one or more processors 304. The memory 308 may be configured to store the data, and the instructions executable by the one or more processors 304 for supply chain management. Further, the memory 308 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 308 may include a cache or random-access memory for the one or more processors 304. In alternative examples, the memory 308 is separate from the one or more processors 304, such as a cache memory of a processor, the system memory, or other memory. The memory 308 may be an external storage device or database for storing data. The memory 308 may be operable to store instructions executable by the one or more processors 304. The functions, acts, or tasks illustrated in the figures or described may be performed by the programmed processor/controller for executing the instructions stored in the memory 308. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of modules 306 may be included within the memory 108. The memory 308 may further include a database 312 to store the data for supply chain management. The plurality of modules 306 may include a set of instructions that may be executed to cause the system 122, 222 to perform any one or more of the methods/processes disclosed herein. The plurality of modules 306 may be configured to perform the steps of the present disclosure using the data stored in the database 312 for supply chain management, as discussed herein. In an embodiment, each of the plurality of modules 306 may be a hardware unit that may be outside the memory 308. Further, the memory 308 may include an operating system 314 for performing one or more tasks of the server unit 118, 218, as performed by a generic operating system 314 in the communications domain. In one embodiment, the database 312 may be configured to store the information as required by the plurality of modules 106 and the one or more processors 304 for supply chain management.

For example, the database 312 stores scanned data of the plurality of device markers 108-A, 120-A, 208-A, the desired device data, the desired product data, processed product data, and the like. The desired device data is indicative of information related to a compatible serial number, information related to the plurality of raw materials 106, 206 or the plurality of products 114 raw material or product which is compatible to be fed into each of the plurality of devices 108, 120, 208.

The database 312 may facilitate display of relevant information on the user interface screen of the input device 210. The database 312 supports efficient data retrieval, processing, and presentation on the user interface contributing to information decision-making regarding the supply chain management.

Further, the present invention also contemplates a computer-readable medium that includes instructions or receives and executes instructions responsive to a propagated signal. Further, the instructions may be transmitted or received over the network via a communication port or interface or using a bus (not shown). The communication port or interface may be a part of the one or more processors 304 or may be a separate component. The communication port may be created in software or may be a physical connection in hardware. The communication port may be configured to connect with a network, external media, the display, or any other components in the server unit 118, 218, or combinations thereof. The connection with the network may be a physical connection, such as a wired Ethernet connection, or may be established wirelessly. Likewise, the additional connections with other components of the server unit 118, 218 may be physical or may be established wirelessly. The network may alternatively be directly connected to the bus. For the sake of brevity, the architecture and standard operations of the operating system 314, the memory 308, the database 312, and the one or more processors 304 are not discussed in detail.

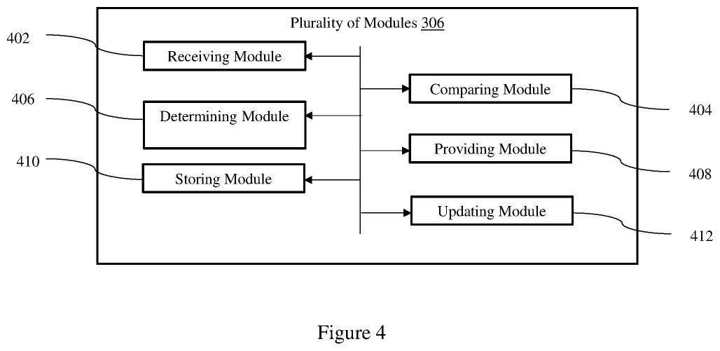

FIG. 4 illustrates a block diagram of a plurality of modules 306 of the system 122, 222 for supply chain management, according to an embodiment of the present disclosure. The illustrated embodiment of FIG. 4 also depicts a sequence flow of processes among the plurality of modules 306 for the supply chain management. In an embodiment of the present disclosure, the plurality of modules 306 may include but is not limited to, a receiving module 402, a comparing module 404, a determining module 406, a providing module 408, a storing module 410, and an updating module 412. The plurality of modules 306 may be implemented by way of suitable hardware and/or software applications.

The receiving module 402 may be configured to receive scanned data associated with a plurality of device markers 108-A, 120-A, 208-A before installing a plurality of devices 108, 120, 208 in at least one manufacturing unit 102 and at least one processing unit 104, 204, and a plurality of product markers 106-A, 114-A, 206-A before feeding a plurality of raw materials 106, 206 and a plurality of products 114 into the plurality of devices 108, 120, 208.

Further, the comparing module 404 may be configured to compare the scanned data of the plurality of device markers 108-A, 120-A, 208-A with desired device data stored in the server unit 118, 218, and the scanned data of the plurality of product markers 106-A, 114-A, 206-A with desired product data stored in the server unit 118, 218. In an embodiment of the present disclosure, the desired device data is indicative of information related to a compatible serial number, information related to the plurality of raw materials 106, 206 or the plurality of products 114 raw material or product which is compatible to be fed into each of the plurality of devices 108, 120, 208.

Furthermore, the determining module 406 may be configured to determine an eligibility of each of the plurality of devices 108, 120, 208 to be installed into the at least one manufacturing unit 102 and the at least one processing unit 104, 204 based on the comparison, and an eligibility of the plurality of raw materials 106, 206 to be fed into the plurality of devices 108, 120, 208 based on the comparison. In an embodiment of the present disclosure, the determining module 406 may be configured to validate user data entered on the input device 210.

In addition, the providing module 408 may be configured to provide information indicative of the eligibility of each of the plurality of devices 108, 120, 208 and the eligibility of the plurality of raw materials 106, 206 as an output to one or more operators associated with the at least one manufacturing unit 102, and the at least one processing unit 104, 204.

Moreover, the updating module 412 may be configured to update the current filled volume data of each of the plurality of devices 108, 120, 208 in real-time, wherein the current filled volume data is indicative of a volume of the plurality of raw materials 106, 206 and the plurality of products 114 inside the plurality of devices 108, 120, 208.

Further, the storing module 410 may be configured to store the desired device data, the desired product data, and processed product data. Furthermore, the storing module 410 may record an output. The output may include, but is not limited to, information indicative of the eligibility of each of the plurality of devices 108, 120, 208 and the eligibility of the plurality of raw materials 106, 206. In an embodiment of the present disclosure, the storing module 410 may store the filled volume data of each of the plurality of devices 108, 120, 208 in real-time.

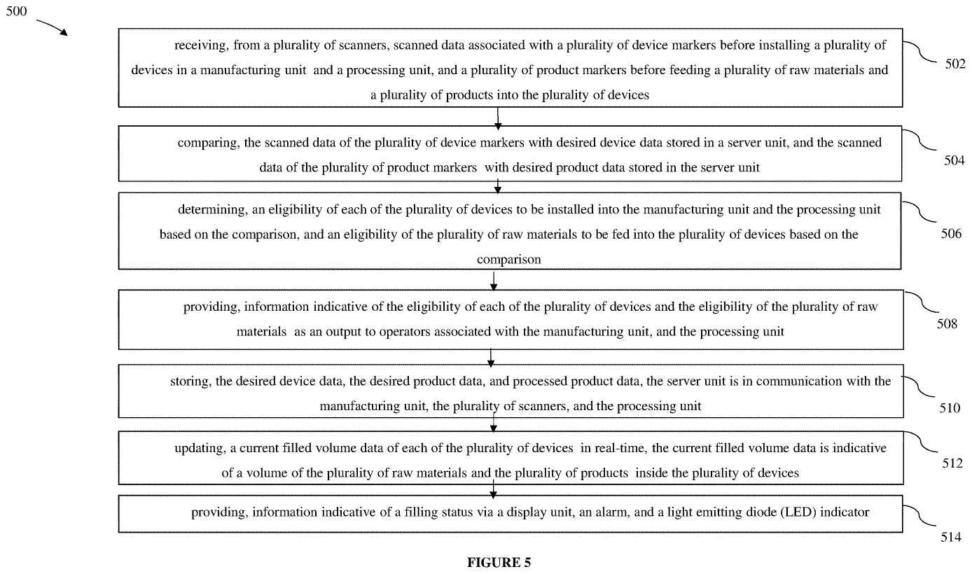

FIG. 5 illustrates a process flow 500 depicting a method of using a system for supply chain management, according to an embodiment of the present disclosure. In one embodiment, the steps of the process 500 may be performed by the system 122, 222, as discussed above.

Initially, at step 502, the method 500 includes receiving, by a server unit 118, 218 of the system 122, 222 for the supply chain management, from a plurality of scanners 110, scanned data associated with a plurality of device markers 108-A, 120-A, 208-A before installing a plurality of devices 108, 120, 208 in at least one manufacturing unit 102 and at least one processing unit 104, 204, and a plurality of product markers 106-A, 114-A, 206-A before feeding a plurality of raw materials 106, 206 and a plurality of products 114 into the plurality of devices 108, 120, 208. The plurality of devices 108, 120, 208 comprises a plurality of manufacturing devices 120, a plurality of processing devices 108, and a plurality of hoppers 208. In an embodiment of the present disclosure, the server unit 118, 218 validates user data entered on the input device 210, the input device 210 comprises a human-machine interface device, the user data indicative of login credentials, preferences, and commands for interaction with the input device 210.

At step 504, the method 500 includes comparing, by the server unit 118, 218, the scanned data of the plurality of device markers 108-A, 120-A, 208-A with desired device data stored in the server unit 118, 218, and the scanned data of the plurality of product markers 106-A, 114-A, 206-A with desired product data stored in the server unit 118, 218. The desired device data is indicative of information related to a compatible serial number, information related to the plurality of raw materials 106, 206 or the plurality of products (114) raw material or product which is compatible to be fed into each of the plurality of devices 108, 120, 208.

At step 506, the method 500 includes determining, by the server unit 118, 218, an eligibility of each of the plurality of devices 108, 120, 208 to be installed into the at least one manufacturing unit 102 and the at least one processing unit 104, 204 based on the comparison, and an eligibility of the plurality of raw materials 106, 206 to be fed into the plurality of devices 108, 120, 208 based on the comparison. In an embodiment, the plurality of devices 108, 120, 208 includes a plurality of manufacturing devices 120, a plurality of processing devices 108, and a plurality of hoppers 208.

At step 508, the method 500 includes providing, by the server unit 118, 218, information indicative of the eligibility of each of the plurality of devices 108, 120, 208 and the eligibility of the plurality of raw materials 106, 206 as an output to one or more operators associated with the at least one manufacturing unit 102, and the at least one processing unit 104, 204.

At step 510, the method 500 includes storing, by the server unit 118, 218, the desired device data, the desired product data, and processed product data, wherein the server unit 118, 218 is in communication with the at least one manufacturing unit 102, the plurality of scanners 110, and the at least one processing unit 104, 204.

At step 512, the method 500 includes updating, by the server unit 118, 218, a current filled volume data of each of the plurality of devices 108, 120, 208 in real-time, wherein the current filled volume data is indicative of a volume of the plurality of raw materials 106, 206 and the plurality of products 114 inside the plurality of devices 108, 120, 208.

At step 514, the method 500 includes providing, by the server unit 118, 218, information indicative of a filling status via at least one of a display unit, an alarm, and a light emitting diode (LED) indicator.

While the above-discussed steps in FIG. 5 are shown and described in a particular sequence, the steps may occur in variations to the sequence in accordance with various embodiments. Further, a detailed description related to the various steps of FIG. 5 is already covered in the description related to FIGS. 1-5 and is omitted herein for the sake of brevity.

The system 122, 222 disclosed herein streamlines all the tracking transactions through the server unit 118, 218 in integration with the Programmable Logical Controller (PLC), thereby making the tracking accurate and timely. Furthermore, the system 122, 222 maintains confidentiality by incorporating a close-loop data exchange system, i.e., in the absence of feedback from the server unit 118, the raw material 106, or the product 114, 206 cannot be validated.

In one embodiment, the system 122, 222 ensures that an authenticated raw material 106 or the product 114, 206 is being fed into the devices 108, 120, or hoppers 208. The system 122, 222 further ensures that devices 108, 120, or hoppers 208 are being installed accurately in a designated location in the production unit 100, 200. The system 122, 222 keeps track of the product data like expiry date, batch number, balance quantity, etc. The system 122, 222 further ensures authenticity and security efficiently, as the devices 108, 120, or hoppers 208 cannot function without authentication by the system 122, 222. In one example, the code 106-A, 114-A, 206-A will remain valid only until the expiry date of the product 106, 114, 206 on which the code 106-A, 114-A, 206-A is attached.

In one embodiment, the system 122, 222 ensures that no device 108, 120, or hoppers 208 can run with a code that has already been marked as deactivated in the server unit 118. In one embodiment, deactivation of codes is possible even in scenarios where the system 122, 222 may not be connected to the server 118.

While specific language has been used to describe the present disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method (500) of using a system for supply chain management, comprising:
receiving (502), by a server unit (118, 218) of the system (122, 222) for the supply chain management, from a plurality of scanners (110), scanned data associated with a plurality of device markers (108-A, 120-A, 208-A) before installing a plurality of devices (108, 120, 208) in at least one manufacturing unit (102) and at least one processing unit (104, 204), and a plurality of product markers (106-A, 114-A, 206-A) before feeding a plurality of raw materials (106, 206) and a plurality of products (114) into the plurality of devices (108, 120, 208);
comparing (504), by the server unit (118, 218), the scanned data of the plurality of device markers (108-A, 120-A, 208-A) with desired device data stored in the server unit (118, 218), and the scanned data of the plurality of product markers (106-A, 114-A, 206-A) with desired product data stored in the server unit (118, 218);
determining (506), by the server unit (118, 218), an eligibility of each of the plurality of devices (108, 120, 208) to be installed into the at least one manufacturing unit (102) and the at least one processing unit (104, 204) based on the comparison, and an eligibility of the plurality of raw materials (106, 206) to be fed into the plurality of devices (108, 120, 208) based on the comparison; and
providing (508), by the server unit (118, 218), information indicative of the eligibility of each of the plurality of devices (108, 120, 208) and the eligibility of the plurality of raw materials (106, 206) as an output to one or more operators associated with the at least one manufacturing unit (102), and the at least one processing unit (104, 204).

2. The method (500) as claimed in claim 1, comprising:
storing (510), by the server unit (118, 218), the desired device data, the desired product data, and processed product data, wherein the server unit (118, 218) is in communication with the at least one manufacturing unit (102), the plurality of scanners (110), and the at least one processing unit (104, 204).

3. The method (500) as claimed in claim 1, wherein the desired device data is indicative of information related to a compatible serial number, information related to the plurality of raw materials (106, 206) or the plurality of products (114) raw material or product which is compatible to be fed into each of the plurality of devices (108, 120, 208).

4. The method (500) as claimed in claim 3, wherein the plurality of devices (108, 120, 208) comprises a plurality of manufacturing devices (120), a plurality of processing devices (108), and a plurality of hoppers (208).

5. The method (500) as claimed in claim 1, comprising:
updating (512), by the server unit (118, 218), a current filled volume data of each of the plurality of devices (108, 120, 208) in real-time, wherein the current filled volume data is indicative of a volume of the plurality of raw materials (106, 206) and the plurality of products (114) inside the plurality of devices (108, 120, 208).

6. The method (500) as claimed in claim 5, comprising:
providing (514), by the server unit (118, 218), information indicative of a filling status via at least one of a display unit, an alarm, and a light emitting diode (LED) indicator.

7. The method (500) as claimed in claim 1, comprising:
validating, by the server unit (118, 218), user data entered on an input device (210), wherein the input device (210) comprises a human machine interface device, the user data indicative of login credentials, preferences, and commands for interaction with the input device (210).

8. A system (122, 222) for a supply chain management, comprising:
a server unit (118, 218) configured to:
receive scanned data associated with a plurality of device markers (108-A, 120-A, 208-A) from a plurality of scanners (110), before installing a plurality of devices (108, 120, 208) into at least one manufacturing unit (102) and at least one processing unit (104, 204), and a plurality of product markers (106-A, 114-A, 206-A) before feeding a plurality of raw materials (106, 206) and a plurality of products (114) into the plurality of devices (108, 120, 208),
compare the scanned data of the plurality of device markers (108-A, 120-A, 208-A) with desired device data stored in the server unit (118, 218), and the scanned data of the plurality of product markers (106-A, 114-A, 206-A) with desired product data stored in the server unit (118, 218),
determine an eligibility of each of the plurality of devices (108, 120, 208) to be installed into the at least one manufacturing unit (102) and the at least one processing unit (104, 204) based on the comparison, and an eligibility of the plurality of raw materials (106, 206) to be fed into the plurality of devices (108, 120, 208) based on the comparison,
provide information indicative of the eligibility of each of the plurality of devices (108, 120, 208) and the eligibility of the plurality of raw materials (106, 206) as an output to one or more operators associated with the at least one manufacturing unit (102), and the at least one processing unit (104, 204).

9. The system (122, 222) as claimed in claim 8, wherein the server unit (118, 218) is configured to store manufacturing unit data, processing unit data, device data, the desired device data, the desired product data, and processed product data, wherein the server unit (118, 218) is in communication with the at least one manufacturing unit (102), the plurality of scanners (110), and the at least one processing unit (104, 204).

10. The system (122, 222) as claimed in claim 8, wherein the desired device data is indicative of information related to a compatible serial number, information related to the plurality of raw materials (106, 206) or the plurality of products (114) which is compatible to be fed into each of the plurality of devices (108, 120, 208).

11. The system (122, 222) as claimed in claim 8, wherein the plurality of devices (108, 120, 208) comprises a plurality of manufacturing devices (120), a plurality of processing devices (108), and a plurality of hoppers (208).

12. The system (122, 222) as claimed in claim 8, wherein the server unit (118, 218) is configured to update current filled volume data of each of the plurality of devices (108, 120, 208) in real-time, wherein the current filled volume data is indicative of a volume of the plurality of raw materials (106, 206) and the plurality of products (114) inside the plurality of devices (108, 120, 208).

13. The system (122, 222) as claimed in claim 8, wherein the server unit (118, 218) is configured to provide information indicative of a filling status via at least one of a display unit, an alarm, and a light emitting diode (LED) indicator.

14. The system (122, 222) as claimed in claim 8, wherein the server unit (118, 218) is configured to validate user data entered on an input device (210), wherein the input device (210) comprises a human machine interface device, the user data indicative of login credentials, preferences, and commands for interaction with the input device (210).
